(19) United States
(12) Patent Application Publication
(10) Pub. No.: US 2026/0213786 A1
(43) Pub. Date: Jul. 23, 2026

(54) MODEL-BASED SELECTION OF MATERIALS FOR RECONFIGURABLE INTELLIGENT SURFACE DEPLOYMENT

(71) Applicant: Dell Products L.P., Round Rock, TX (US)

(72) Inventors: Seán Ahearne, Cork (IE); Tejinder Singh, Manotick (CA); Navjot Kaur Khaira, Manotick (ON)

(21) Appl. No.: 19/030,324

(22) Filed: Jan. 17, 2025

(51) Int. Cl. H04B 7/04; H04L 41/16

(52) U.S. Cl. CPC H04B 7/04013; H04L 41/16

(57) ABSTRACT

The technology described herein is directed towards selection of materials for a reconfigurable intelligent surface based on planned deployment parameter data input into a trained model, including but not limited to environmental data condition data and desired performance data. Artificial intelligence/machine learning models, such as random forest regression models and/or neural network modes, are trained to analyze a variety of factors relevant to the reconfigurable intelligent surface deployment, including the planned deployment parameter data and material characteristic data of various candidate materials. The trained model set (one or more trained models) outputs recommendation data, such as a score for a set of proposed materials, or a list of recommended materials to use in the reconfigurable intelligent surface deployment. The trained model set, along with a simulator modeling tool can also provide placement (deployment location) recommendation data for the reconfigurable intelligent surface and other reconfigurable intelligent surfaces.

### BACKGROUND

A reconfigurable intelligent surface includes an array of elements that can redirect wireless signals to a target, such as to get around an obstacle when a direct line-of-sight path from a source to the target is not available. The deployment of a reconfigurable intelligent surface thus enhances wireless communication networks, particularly in diverse and challenging environments. However, each deployment scenario has different factors needing consideration.

### BRIEF DESCRIPTION OF THE DRAWINGS

The technology described herein is illustrated by way of example and not limited in the accompanying figures in which like reference numerals indicate similar elements and in which:

FIG. 1A is a block diagram of an example system including a trained model for recommendation data corresponding to materials for reconfigurable intelligent surface deployment, in accordance with various embodiments and implementations of the subject disclosure.

FIG. 1B is a block diagram of an alternative example system including a trained model for recommendation data corresponding to materials for reconfigurable intelligent surface deployment, in accordance with various embodiments and implementations of the subject disclosure.

FIGS. 2-5 represent an example process showing measurement and data collection input into a trained model, and output of viable reconfigurable intelligent surface links and reconfigurable intelligent surface material data, in accordance with various embodiments and implementations of the subject disclosure.

FIG. 6 is a representation of example reconfigurable intelligent surface deployment parameter data input into a random forest regression model to obtain recommendation data corresponding to materials for reconfigurable intelligent surface deployment, in accordance with various embodiments and implementations of the subject disclosure.

FIGS. 7 and 8 comprise a representation of an example neural network operating with example reconfigurable intelligent surface deployment parameters, in accordance with various embodiments and implementations of the subject disclosure.

FIG. 9 is a flow diagram showing example operations related to inputting reconfigurable intelligent surface deployment parameter data into a trained model to obtain recommended data corresponding to reconfigurable intelligent surface materials for the planned deployment, in accordance with various embodiments and implementations of the subject disclosure.

FIG. 10 is a flow diagram showing example operations related to inputting a dataset based on deployment parameter data representative of a planned deployment of a reconfigurable intelligent surface, to a trained model to obtain recommendation data representative of material usage data for the reconfigurable intelligent surface, in accordance with various embodiments and implementations of the subject disclosure.

FIG. 11 is a flow diagram showing example operations related to obtaining first and second scores for first and second sets of candidate materials for planned deployment of a reconfigurable intelligent surface, in accordance with various embodiments and implementations of the subject disclosure.

### DETAILED DESCRIPTION

The technology described herein is generally directed towards selecting materials for the deployment of a reconfigurable intelligent surfaces (RIS), which can vary based on the type of environment in which a RIS deployment is planned. Each deployment scenario for an environment, whether urban, rural, indoor, or extreme, can present different environmental conditions and performance specifications or requirements, and there are numerous candidate RIS materials to choose from, thus making selection of RIS materials for constructing RIS units a complex task.

Described herein is an artificial intelligence (AI)-driven solution that can dynamically optimize material selection based on thorough and up-to-date deployment parameter data for a given scenario in which the RIS, when deployed, has to perform well under varying environmental conditions and in view of other deployment considerations. Note that this is in contrast to traditional methods for material selection that rely heavily on fixed criteria or empirical testing, which are often insufficient for addressing the dynamic and multifaceted nature of real-world deployments, leading to suboptimal performance, higher costs, and increased maintenance needs.

It should be understood that any of the examples herein are non-limiting. As one example, various artificial intelligent models are described; however these are nonlimiting examples, and other models, including those not yet developed, can be leveraged by the technology described herein. Thus, any of the embodiments, aspects, concepts, structures, functionalities, or examples described herein are non-limiting, and the technology may be used in various ways that provide benefits and advantages in communications and reconfigurable intelligent surfaces in general. It also should be noted that terms used herein, such as “optimize” or “optimal” and the like only represent objectives to move towards a more optimal state, rather than necessarily obtaining ideal results.

Reference throughout this specification to “one embodiment,” “an embodiment,” “one implementation,” “an implementation,” etc. means that a particular feature, structure, or characteristic described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations. Repetitive description of like elements employed in respective embodiments may be omitted for sake of brevity.

The following detailed description is merely illustrative and is not intended to limit embodiments and/or application or uses of embodiments. Furthermore, there is no intention to be bound by any expressed or implied information presented in the preceding sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Further, it is to be understood that the present disclosure will be described in terms of a given illustrative architecture; however, other architectures, structures, substrate materials and process features, and steps can be varied within the scope of the present disclosure.

Aspects of the subject disclosure will now be described more fully hereinafter with reference to the accompanying drawings in which example components, graphs and/or operations are shown. In the following description, for purposes of explanation, numerous specific details are set forth in order to provide a thorough understanding of the various embodiments. However, the subject disclosure may be embodied in many different forms and should not be construed as limited to the examples set forth herein.

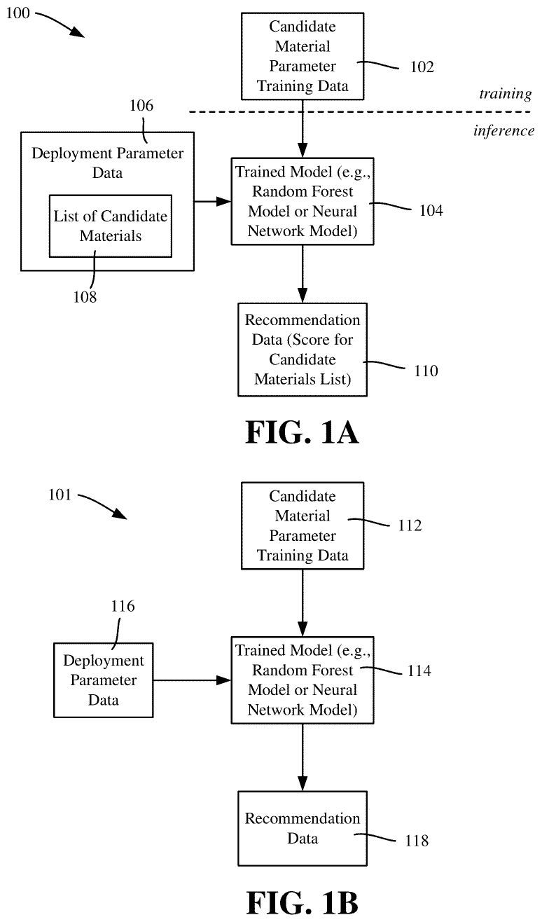

FIG. 1A shows an example system 100 in which candidate material parameter training data 102 is used to train an AI model 104, such as a random forest regression model or a neural network model. Among the nonlimiting examples described herein, various available candidate materials can have different dielectric constants, different temperature and humidity characteristics, different corrosion resistance qualities, and so on. Thus, nonlimiting examples of material properties include dielectric constant data, conductivity data, thermal stability data, durability data, cost data, and environmental sustainability metrics.

Once trained, the model 104 can be used to assist in material selection for a planned RIS deployment. Deployment parameter data 106, such as information regarding environmental conditions in the planned deployment scenario like temperature, humidity, precipitation, urban density, air quality, indoor and outdoor variables, reflectivity (e.g., of objects, such as robots in a factory), and so on. The deployment parameter data 106 also can include performance-related metrics such as coverage area, signal-to-noise ratio data, data throughput, and longevity under various conditions, and so on.

In the example implementation of FIG. 1A, the deployment parameter data input to the trained model can also include a list of candidate materials 108, such as copper for the unit cells' resonating layer and ground plane, silicon for the unit cells' substrate, materials by which the RIS is attached to a structure/post, protective coating material for the unit cells, and so on; cost can also be a significant factor; for example, gold is very resistant to corrosion, but is likely too expensive to use in the unit cells for most deployment scenarios. In the example of FIG. 1A, based on the deployment parameter data including the list of candidate materials 108, the trained model can output recommendation data 110 in the form of a score or the like indicative of how suitable the listed candidate materials are for the planned RIS deployment. For example, a set of candidate materials that are less sensitive to temperature will likely score higher for an outdoor deployment in climates having large temperature swings, yet not score as well for indoor deployment scenarios. A designer can thus input many combinations of available materials, and receive a score for each such combination.

FIG. 1B shows a system 101 similar to FIG. 1A, however in this example system, the trained model 114 is configured to output recommendation data 118 one or more lists of materials to use, possibly with information indicative of the pros and cons associated with each list, and/or for each material in a list. In general, there can be any number of ways that recommendation data can be conveyed, and the technology described herein is not limited to any one way.

In general, the use of a trained model to assist with planned RIS deployment facilitates a more sophisticated approach to material selection than traditional approaches, resulting in informed, data-driven decisions. Traditional material selection methods are inadequate for this task as they are unable to consider the complex and simultaneous interplay of factors such as signal propagation characteristics, durability, cost, and environmental sustainability, which can lead to selection of materials that may excel in one area but fail in another, when both areas of consideration may be significant with respect to a RIS deployment.

Further, the technology described herein is capable of regular and/or continuous learning from new data and adapting to changing conditions, such that the trained model provides accurate, up-to-date, and context-specific material recommendations. In one implementation, the trained model can be integrated into a simulator tool that works with three-dimensional (3D) models of environments, enabling detailed and precise analysis for more optimal decision-making.

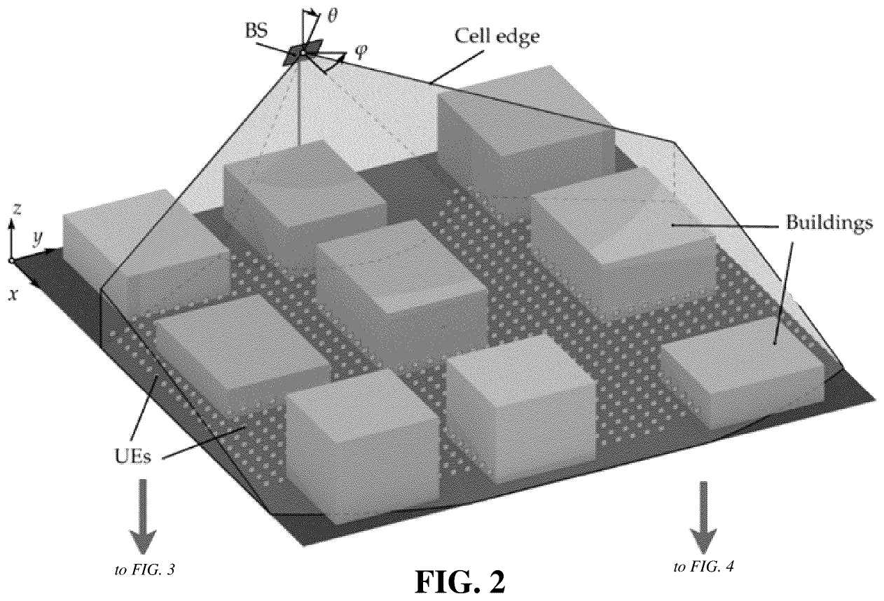

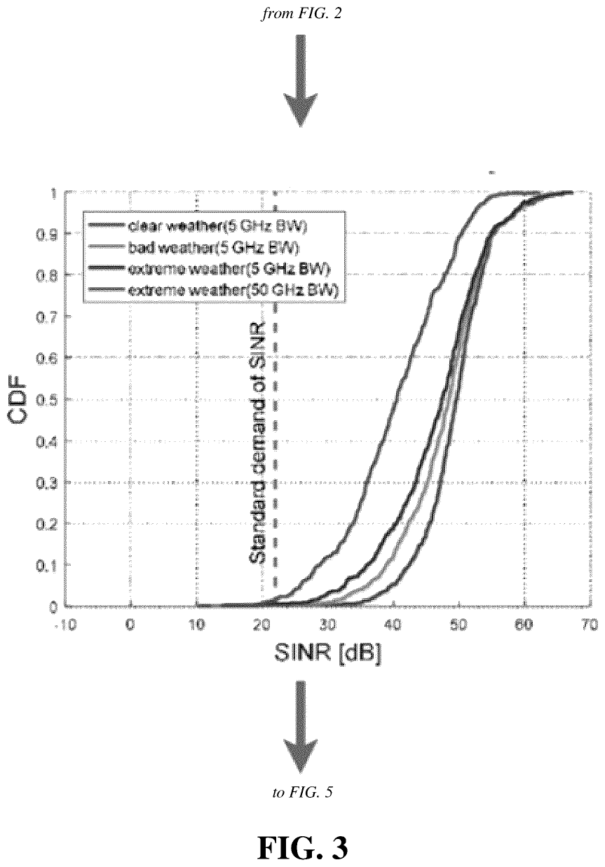

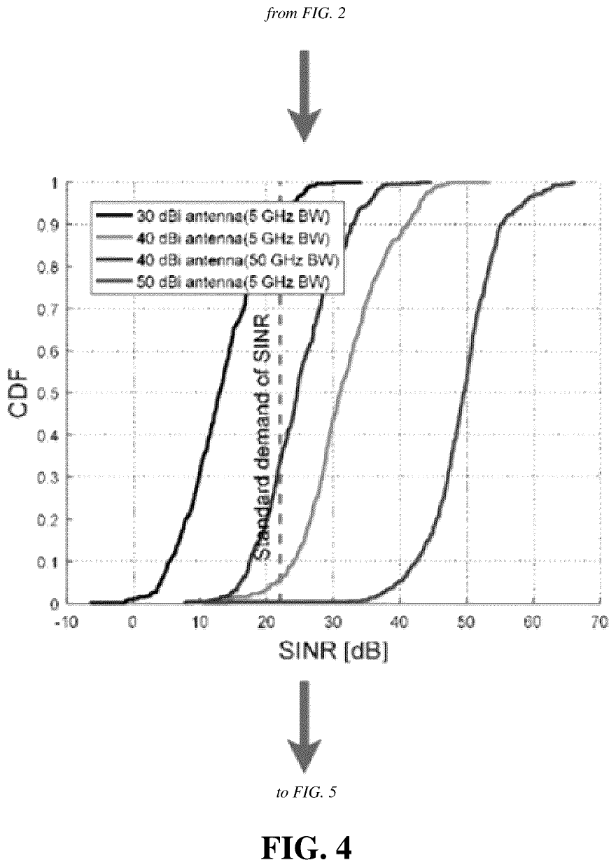

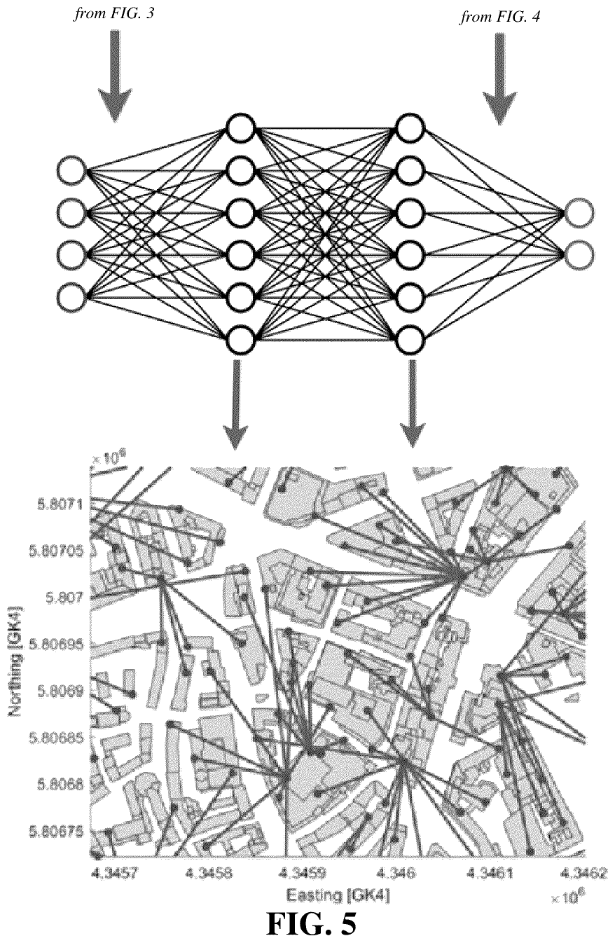

The comprehensive data collection and analysis process ensures that many relevant factors are taken into account, providing a holistic and dynamic approach to material selection. An example of the solution implementation can be seen in FIGS. 2-5 , showing data collection from either real or simulated measurement of a 3D environment incorporating RIS links. This data is processed and input as parameters into a trained model that is designed to optimally find the best RIS material choices within that environment, possibly along with placement data (locations) for RIS links within that environment. Note that some of the input data can be captured by drones configured to perform wireless network surveys.

Example AI models suitable for material selection include random forest regression and neural networks (NN). One or both models can be selected for their individual strengths and suitability for different aspects of the material selection process.

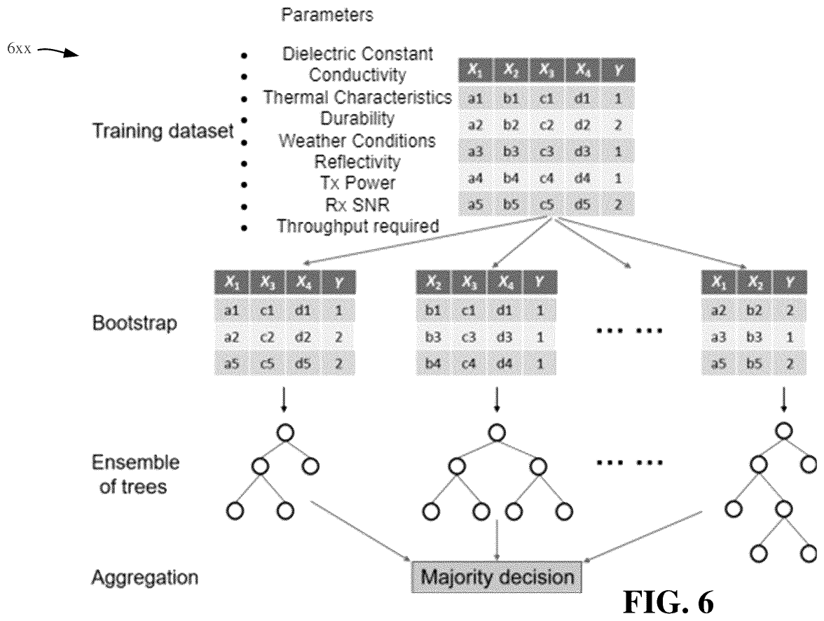

FIG. 6 shows the concept of a random forest regression model for RIS material selection, based on a systematic approach to data collection, preprocessing, training, and optimization. Random forest regression handles the complex, multidimensional datasets associated with an optimal RIS deployment.

The training process for random forest regression begins with data preparation. For RIS material selection, a variety of parameter data are gathered to provide a reasonably comprehensive dataset. Such deployment parameter data include material properties such as dielectric constant, conductivity, thermal stability, mechanical durability, cost, and environmental sustainability metrics. Environmental conditions are also input as part of the deployment parameter data, and include factors like temperature, humidity, precipitation, urban density, air quality, and reflectivity. Additionally, indoor/outdoor variables such as building materials and layout, vegetation density, and user density are considered via input data. In general, such conditions significantly affect signal propagation and material performance. Performance metrics are also part of the input data, and include coverage area, signal-to-noise ratio, data throughput, and the longevity of materials under various conditions. These metrics provide benchmarks for evaluating the effectiveness of different materials in specific deployment scenarios.

Once the deployment parameter data is collected, the data is preprocessed for quality and consistency. In general, this involves normalizing the values to a common scale, handling missing data through imputation or removal, and splitting the data into training and testing sets, such as with eighty percent of the data used for training and twenty percent for testing. This split allows the model to learn from a large portion of the data while preserving a separate set for validation and testing.

During the training process, the random forest model builds multiple decision trees from random subsets of the training data. Each tree is constructed by splitting the data at various decision points based on the input parameters, creating a series of nodes that represent different conditions and outcomes. The trees are trained independently, and each tree makes its own prediction. The final output of the model is the average of all (or at least almost all) tree predictions, providing a robust and accurate estimate of material performance.

Bootstrap aggregation, or bagging, can be part of the random forest regression model training process. Bootstrap aggregation involves generating multiple bootstrap samples from the original dataset by randomly sampling with replacement. Each bootstrap sample is used to train a different tree in the forest. This process helps to reduce variance and prevent overfitting, ensuring that the model generalizes well with new data. The use of multiple trees, each trained on different subsets of the data, allows the model to capture a wide range of patterns and interactions, improving its predictive accuracy.

Random forest regression is particularly advantageous for RIS material selection due to its ability to handle a large number of input variables and its robustness to overfitting. The random forest regression model provides valuable insights into feature importance, helping to identify which factors most impact overall performance. This interpretability is beneficial in understanding the relationships between material properties, environmental conditions, and performance metrics. Random forest regression is appropriate for scenarios where interpretability and robustness are significant, making it highly effective in environments with diverse and complex datasets. By providing insights into material properties and environmental impacts, random forest regression supports informed decision-making and optimized material selection, ensuring that RIS deployments achieve the appropriate level of performance and sustainability.

Neural networks for RIS material selection involves a comprehensive approach to data collection, preprocessing, model design, and implementation. Neural networks are particularly suitable for modelling complex, non-linear relationships between parameters, offering high predictive power which is appropriate for capturing the intricate interactions in RIS material performance under various environmental conditions.

To begin with, the parameters collected for input into the neural network include detailed material properties, environmental conditions, and performance metrics. This dataset can be similar to the random forest regression example of FIG. 6, containing information on RIS material properties, device performance, and environmental conditions. The data is then normalized and preprocessed to ensure it is suitable for neural network training. This involves scaling the data to a common range, handling any missing values, and splitting the dataset into training, validation, and testing sets, such as seventy percent for training, fifteen percent for validation, and fifteen percent for testing.

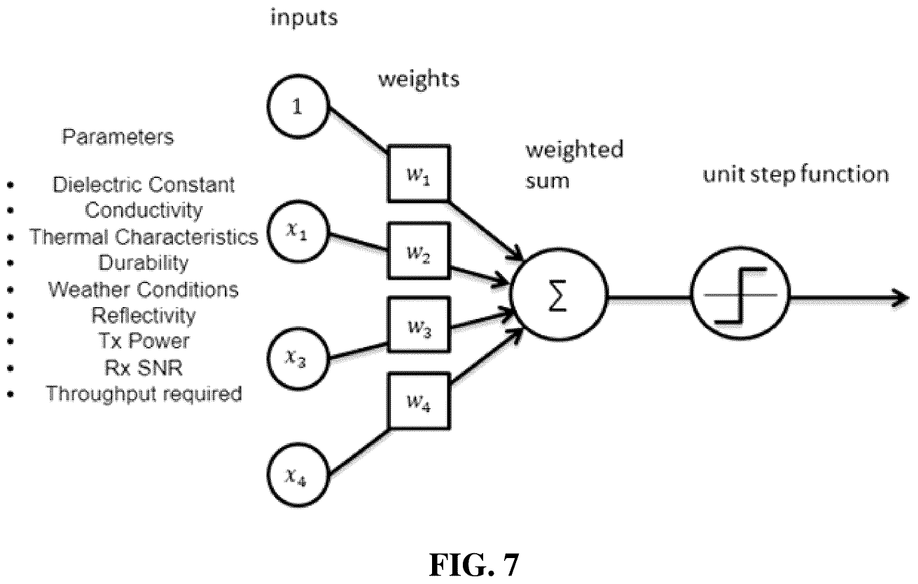

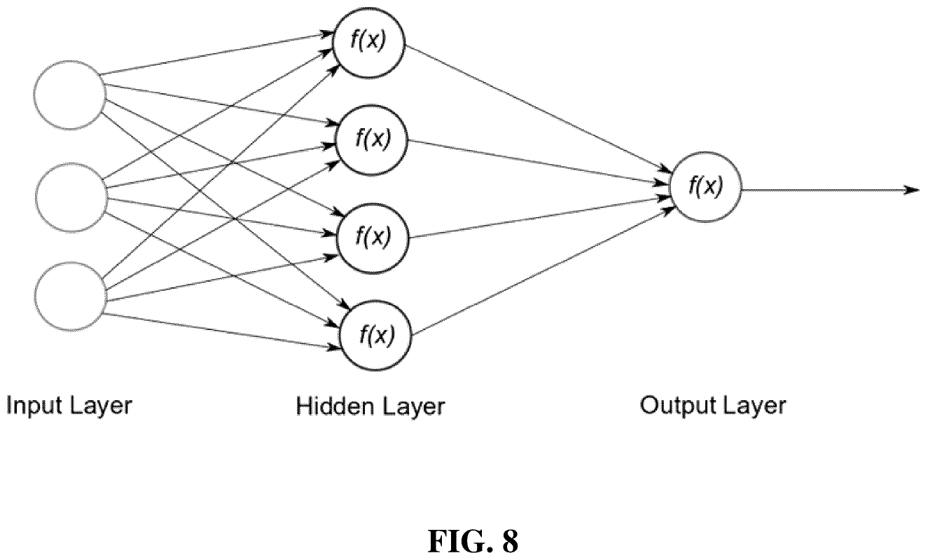

As shown in FIGS. 7 and 8, the design of a suitable neural network for RIS material selection includes defining the architecture, which includes the input layer, hidden layers, and the output layer. The input layer includes respective nodes corresponding to the respective input parameters, ensuring that the relevant data points are considered. Each node in the input layer represents a normalized value of a specific parameter, such as dielectric constant or temperature.

Hidden layers are designed to capture the non-linear relationships between input parameters. The number of hidden layers and the number of nodes in each layer can vary, but a one such approach can involve multiple layers with progressively fewer nodes, allowing the network to learn increasingly abstract representations of the input data. Each node in a hidden layer receives inputs from the nodes in the previous layer, with each connection having an associated weight. The fundamental operations in each node include calculating the weighted sum of the inputs and applying a step function (activation function). The step function, or activation function, is then applied to the weighted sum to introduce nonlinearity into the model. This process is repeated for each node in the hidden layers, with the outputs of one layer serving as the inputs for the next. The output layer is generally a single node when predicting a continuous value, or multiple nodes when performing classification. In the case of RIS material selection, the output can be a predicted performance metric such as the expected signal-to-noise ratio or data throughput for a given set of input parameters. These outputs can then ultimately combine into a full RIS selection recommendation for the given environment.

The training process involves adjusting the weights and biases to minimize the difference between the predicted outputs and the actual performance metrics. This is achieved through backpropagation, where the error is calculated at the output layer and propagated backward through the network, updating the weights and biases using an optimization algorithm such as gradient descent.

Implementation of the neural network can be performed using a deep learning framework like TENSORFLOW or PYTORCH. These frameworks provide tools for defining the network architecture, processing the data, and optimizing the model parameters. The training is typically conducted on a GPU for faster processing, with training times varying based on network complexity and data size. Large, complex models may require distributed training on a high-performance computing cluster.

Neural networks are particularly advantageous for RIS material selection when dealing with highly variable conditions and materials with complex interactions. Neural networks provide superior predictive accuracy by learning deep representations of the data, capturing intricate patterns that might be missed by simpler models. This makes neural networks appropriate for advanced simulation scenarios where maximizing prediction performance is more significant than interpretability. By accurately modelling the non-linear relationships between input parameters, neural networks can provide highly tailored and effective material recommendations for specific deployment scenarios.

As set forth therein, the AI system can be integrated into a simulator tool that allows users to input 3D models of environments, enabling precise analysis of how different materials will perform in specific settings. This capability can provide highly-accurate and tailored recommendations, ensuring optimal material selection for each unique deployment scenario. By continuously learning from new data and adapting to changing conditions, the AI-driven approach can provide accurate and context-specific material recommendations, significantly enhancing the performance, cost efficiency, durability, and adaptability of RIS deployments.

Note that the random forest model and the neural network model can solve the material selection problem; however, these different models may be more useful at different stages of development, whereby both can be used. Random forest regression is an easily interpretable model with a relatively short training time, making random forest regression very useful during the development phase for understanding the weights and relationships between variables (e.g. transmission power available at certain temperatures) and how they affect the final output. In contrast, neural network models are not easily interpretable models and have a relatively long training time, but when weighted and trained correctly can provide a more accurate final output, which is desirable.

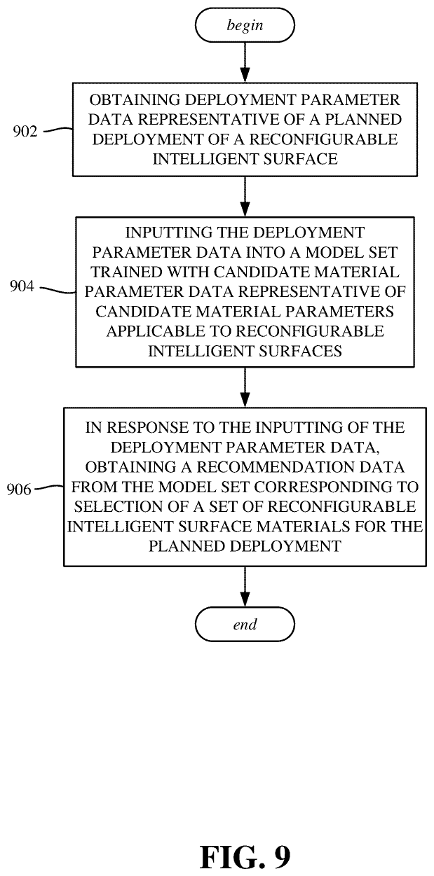

One or more implementations can be embodied in a system, such as represented in the example operations of FIG. 9, and for example can include at least one processor memory that stores computer executable components and/or operations, and at least one processor that executes computer executable components and/or operations stored in the memory. Example operations can include operation 902, which represents obtaining deployment parameter data representative of a planned deployment of a reconfigurable intelligent surface. Example operation 904 represents inputting the deployment parameter data into a model set trained with candidate material parameter data representative of candidate material parameters applicable to reconfigurable intelligent surfaces. Example operation 806 represents, in response to the inputting of the deployment parameter data, obtaining a recommendation data from the model set corresponding to selection of a set of reconfigurable intelligent surface materials for the planned deployment.

The deployment parameter data can include placement data for location of the reconfigurable intelligent surface within a planned deployment environment.

The deployment parameter data can include at least one of: environmental condition data representative of an environmental condition associated with the planned deployment, signal propagation characteristic data representative of signal propagation characteristic associated with the planned deployment, cost data representative of a cost associated with the planned deployment, longevity data representative of a longevity associated with the planned deployment or durability data representative of a durability associated with the planned deployment.

The environmental condition data can include at least one of: temperature data representative of a temperature associated with the planned deployment, humidity data representative of a humidity associated with the planned deployment, precipitation data representative of a precipitation associated with the planned deployment, object reflectivity data representative of an object reflectivity associated with the planned deployment, or air quality data representative of an air quality associated with the planned deployment.

The candidate material parameter data can include at least one of: thermal stability data representative of thermal stabilities associated with the candidate material parameters, or environmental sustainability metric data representative of environmental sustainability metrics associated with the candidate material parameters.

The deployment parameter data can include at least one of: coverage area data representative of a coverage area of the reconfigurable intelligent surface, user equipment density data representative of a density of user equipment in the coverage area, signal quality data representative of a specified signal quality for the coverage area, or data throughput data representative of a specified data throughput for the coverage area.

At least part of the candidate material parameter data can correspond to candidate materials for unit cells of the reconfigurable intelligent surface.

The candidate materials for the unit cells can include at least one of: dielectric constant data for candidate substrate materials of the unit cells, or conductivity data for candidate metallic elements of the unit cells.

The recommendation data can include a relative score for a specified set of reconfigurable intelligent surface materials.

The recommendation data can include relative scores for different sets of reconfigurable intelligent surface materials.

The recommendation data can include a combination of reconfigurable intelligent surface materials recommended for the planned deployment.

The model set can include a random forest regression model.

The model set can include a neural network model.

Further operations can include preprocessing the candidate material parameter data into a dataset for training the model set, which can include at least one of: normalizing the candidate material parameter data, scaling the candidate material parameter data to a common range in the dataset, compensating for missing candidate material parameter data values in the dataset, removing outlier candidate material parameter data values from the candidate material parameter data, or splitting the dataset into training, validation, and testing sets.

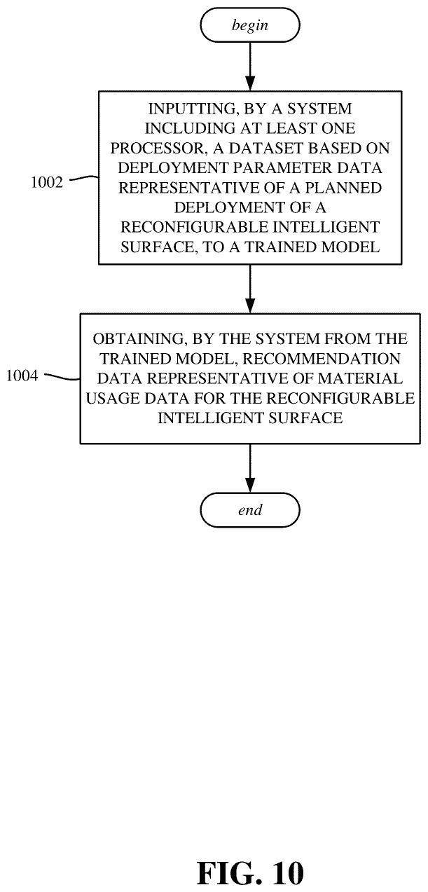

One or more example embodiments and/or implementations, such as corresponding to example operations of a method, can be represented in FIG. 10. Example operation 1002 represents inputting, by a system including at least one processor, a dataset based on deployment parameter data representative of a planned deployment of a reconfigurable intelligent surface, to a trained model. Example operation 1004 represents obtaining, by the system from the trained model, recommendation data representative of material usage data for the reconfigurable intelligent surface.

Further operations can include obtaining, by the system from the trained model, placement location for locating the reconfigurable intelligent surface in an environment.

The trained model set can include a random forest model, the deployment parameter data can include a set of selected materials, and the recommendation data can include a score associated with the set of selected materials.

The trained model set can include a neural network model having an input layer, at least one hidden later, and an output layer, and the input layer can include respective nodes corresponding to respective parameters within the dataset.

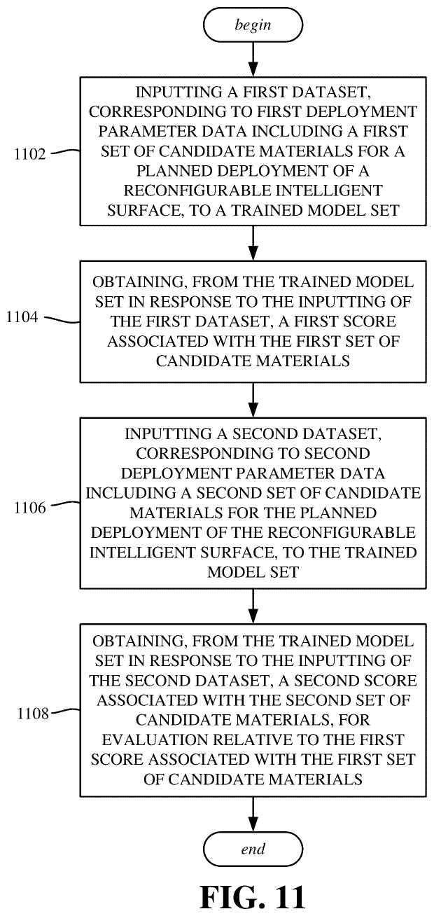

FIG. 11 summarizes various example operations, e.g., corresponding to a machine-readable medium, including executable instructions that, when executed by a processor of a target cluster, facilitate performance of operations. Example operation 1102 represents inputting a first dataset, corresponding to first deployment parameter data including a first set of candidate materials for a planned deployment of a reconfigurable intelligent surface, to a trained model set. Example operation 1104 represents obtaining, from the trained model set in response to the inputting of the first dataset, a first score associated with the first set of candidate materials. Example operation 1106 represents inputting a second dataset, corresponding to second deployment parameter data including a second set of candidate materials for the planned deployment of the reconfigurable intelligent surface, to the trained model set. Example operation 1108 represents obtaining, from the trained model set in response to the inputting of the second dataset, a second score associated with the second set of candidate materials, for evaluation relative to the first score associated with the first set of candidate materials.

Further operations can include preprocessing the first deployment parameter data to obtain the first dataset, and preprocessing the second deployment parameter data to obtain the second dataset.

As can be seen, the technology described herein facilitates material selection for RIS deployments based on trained AI models that can analyze extensive and diverse deployment-related datasets. The AI models can be updated when specified or as needed; such dynamic capability allows for more accurate, context-specific recommendations, ensuring that RIS units perform optimally across various scenarios. By integrating machine learning models with materials science, the technology described herein provides a comprehensive and adaptive method for optimizing RIS performance. The integration of a 3D simulation tool can further enhance the system's capability by enabling detailed and precise environmental modeling, allowing for more accurate predictions and informed decision-making.

To summarize, enhanced RIS performance is achieved by selecting appropriate materials for each deployment scenario, by which the system ensures more optimal signal strength, coverage, and reliability. Cost efficiency is also achieved, as the AI-driven material selection can identify cost-effective materials that meet performance specifications or requirements, reducing overall deployment costs. The system can prioritize materials that not only perform well, but also offer durability and environmental sustainability, extending the lifespan of RIS installations and reducing maintenance needs. The AI system can be quickly adapted to new RIS types, new materials, and evolving environmental conditions, maintaining more optimal performance as new data and devices become available.

What has been described above include mere examples. It is, of course, not possible to describe every conceivable combination of components, materials, or the like for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices, and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor; and
a memory that stores executable instructions that, when executed by the processor, facilitate performance of operations, the operations comprising:
obtaining deployment parameter data representative of a planned deployment of a reconfigurable intelligent surface;
inputting the deployment parameter data into a model set trained with candidate material parameter data representative of candidate material parameters applicable to reconfigurable intelligent surfaces; and
in response to the inputting of the deployment parameter data, obtaining a recommendation data from the model set corresponding to selection of a set of reconfigurable intelligent surface materials for the planned deployment.

2. The system of claim 1, wherein the deployment parameter data comprises placement data for location of the reconfigurable intelligent surface within a planned deployment environment.

3. The system of claim 1, wherein the deployment parameter data comprises at least one of: environmental condition data representative of an environmental condition associated with the planned deployment, signal propagation characteristic data representative of signal propagation characteristic associated with the planned deployment, cost data representative of a cost associated with the planned deployment, longevity data representative of a longevity associated with the planned deployment or durability data representative of a durability associated with the planned deployment.

4. The system of claim 3, wherein the environmental condition data comprises at least one of: temperature data representative of a temperature associated with the planned deployment, humidity data representative of a humidity associated with the planned deployment, precipitation data representative of a precipitation associated with the planned deployment, object reflectivity data representative of an object reflectivity associated with the planned deployment, or air quality data representative of an air quality associated with the planned deployment.

5. The system of claim 1, wherein the candidate material parameter data comprises at least one of: thermal stability data representative of thermal stabilities associated with the candidate material parameters, or environmental sustainability metric data representative of environmental sustainability metrics associated with the candidate material parameters.

6. The system of claim 1, wherein the deployment parameter data comprises at least one of: coverage area data representative of a coverage area of the reconfigurable intelligent surface, user equipment density data representative of a density of user equipment in the coverage area, signal quality data representative of a specified signal quality for the coverage area, or data throughput data representative of a specified data throughput for the coverage area.

7. The system of claim 1, wherein at least part of the candidate material parameter data corresponds to candidate materials for unit cells of the reconfigurable intelligent surface.

8. The system of claim 7, wherein the candidate materials for the unit cells comprise at least one of: dielectric constant data for candidate substrate materials of the unit cells, or conductivity data for candidate metallic elements of the of the unit cells.

9. The system of claim 1, wherein the recommendation data comprises a relative score for a specified set of reconfigurable intelligent surface materials.

10. The system of claim 1, wherein the recommendation data comprises relative scores for different sets of reconfigurable intelligent surface materials.

11. The system of claim 1, wherein the recommendation data comprises a combination of reconfigurable intelligent surface materials recommended for the planned deployment.

12. The system of claim 1, wherein the model set comprises a random forest regression model.

13. The system of claim 1, wherein the model set comprises a neural network model.

14. The system of claim 1, wherein the operations further comprise:
preprocessing the candidate material parameter data into a dataset for training the model set, comprising at least one of: normalizing the candidate material parameter data, scaling the candidate material parameter data to a common range in the dataset, compensating for missing candidate material parameter data values in the dataset, removing outlier candidate material parameter data values from the candidate material parameter data, or splitting the dataset into training, validation, and testing sets.

15. A method, comprising,
inputting, by a system comprising at least one processor, a dataset based on deployment parameter data representative of a planned deployment of a reconfigurable intelligent surface, to a trained model; and
obtaining, by the system from the trained model, recommendation data representative of material usage data for the reconfigurable intelligent surface.

16. The method of claim 15, further comprising obtaining, by the system from the trained model, placement location for locating the reconfigurable intelligent surface in an environment.

17. The method of claim 15, wherein the trained model set comprises a random forest model, wherein the deployment parameter data comprises a set of selected materials, and wherein the recommendation data comprises a score associated with the set of selected materials.

18. The method of claim 15, wherein the trained model set comprises a neural network model having an input layer, at least one hidden later, and an output layer, and wherein the input layer comprises respective nodes corresponding to respective parameters within the dataset.

19. A non-transitory machine-readable medium, comprising executable instructions that, when executed by at least one processor, facilitate performance of operations, the operations comprising:
inputting a first dataset, corresponding to first deployment parameter data comprising a first set of candidate materials for a planned deployment of a reconfigurable intelligent surface, to a trained model set;
obtaining, from the trained model set in response to the inputting of the first dataset, a first score associated with the first set of candidate materials;
inputting a second dataset, corresponding to second deployment parameter data comprising a second set of candidate materials for the planned deployment of the reconfigurable intelligent surface, to the trained model set; and
obtaining, from the trained model set in response to the inputting of the second dataset, a second score associated with the second set of candidate materials, for evaluation relative to the first score associated with the first set of candidate materials.

20. The non-transitory machine-readable medium of claim 19, wherein the operations further comprise:
preprocessing the first deployment parameter data to obtain the first dataset; and
preprocessing the second deployment parameter data to obtain the second dataset.
